(19) United States
(12) Patent Application Publication
(10) Pub. No.: US 2013/0148231 A1
(43) Pub. Date: Jun. 13, 2013

(54) SUSPENSION ASSEMBLY FORMED WITH A PROTECTIVE STRUCTURE

(71) Applicants: Fu-Ying Huang, San Jose, CA (US); Lidu Huang, Danville, CA (US); Yiduo Zhang, Cupertino, CA (US)

(72) Inventors: Fu-Ying Huang, San Jose, CA (US); Lidu Huang, Danville, CA (US); Yiduo Zhang, Cupertino, CA (US)

(73) Assignee: Hitachi Global Storage Technologies Netherlands B.V., Amsterdam (NL)

(21) Appl. No.: 13/316,288

(22) Filed: Dec. 9, 2011

(51) Int. Cl. G11B 5/02; F16M 13/00

(52) U.S. Cl. 360/59; 248/342; G9B/5.026

(57) ABSTRACT

A magnetic disk drive system that has a suspension assembly that includes a slider having a heating element and a suspension configured with a protective structure that protects the heating element. The heating element of the slider can extend through the suspension to extend from the suspension assembly from a side that is opposite the slider. The protective structure is configured to protect the heating element and to prevent the heating element from contacting the heating element of an adjacent suspension during an event such as a physical shock to the disk drive system.

### FIELD OF THE INVENTION

The present invention relates to magnetic data recording and more particularly to a suspension assembly having a protective feature for preventing contact between components of magnetic heads of adjacent suspension assemblies.

### BACKGROUND OF THE INVENTION

The heart of a computer is an assembly that is referred to as a magnetic disk drive. The magnetic disk drive includes a rotating magnetic disk, write and read heads that are suspended by a suspension adjacent to a surface of the rotating magnetic disk and an actuator that swings the suspension to place the read and write heads over selected circular tracks on the rotating disk. The read and write heads are directly located on a slider that has an air bearing surface (ABS). The suspension biases the slider into contact with the surface of the disk when the disk is not rotating, but when the disk rotates air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing and reading functions.

The write head can include at least one coil, a write pole and one or more return poles. When a current flows through the coil, a resulting magnetic field causes a magnetic flux to flow through the write pole, which results in a magnetic write field emitting from the tip of the write pole. This magnetic field is sufficiently strong that it locally magnetizes a portion of the adjacent magnetic disk, thereby recording a bit of data.

A magnetoresistive sensor such as a Giant Magnetoresistive (GMR) sensor, or a Tunnel Junction Magnetoresisive (TMR) sensor can be employed to read a magnetic signal from the magnetic media. The sensor includes .a nonmagnetic conductive layer (if the sensor is a GMR sensor) or a thin nonmagnetic, electrically insulating barrier layer (if the sensor is a TMR sensor) sandwiched between first and second ferromagnetic layers, hereinafter referred to as a pinned layer and a free layer. Magnetic shields are positioned above and below the sensor stack and can also serve as first and second electrical leads so that the electrical current travels perpendicularly to the plane of the free layer, spacer layer and pinned layer (current perpendicular to the plane (CPP) mode of operation). The magnetization direction of the pinned layer is pinned perpendicular to the air bearing surface (ABS) and the magnetization direction of the free layer is located parallel to the ABS, but free to rotate in response to external magnetic fields. The magnetization of the pinned layer is typically pinned by exchange coupling with an antiferromagnetic layer. When the magnetizations of the pinned and free layers are parallel with respect to one another, scattering of the conduction electrons is minimized and when the magnetizations of the pinned and free layer are antiparallel, scattering is maximized. In a read mode the resistance of the spin valve sensor changes about linearly with the magnitudes of the magnetic fields from the rotating disk. When a sense current is conducted through the spin valve sensor, resistance changes cause potential changes that are detected and processed as playback signals.

In an effort to increase data density and thermal stability researchers have developed thermally assisted recording. At very small bit sizes, the magnetic bits on a media become inherently unstable. In order to prevent these very small bits from becoming inadvertently de-magnetized, the magnetic coercivity of the magnetic medium must be very high. However, if the magnetic coercivity is very high, the write head cannot record to the media. In order to overcome this, the slider can be equipped with a heating device, such as a laser, that can locally heat the media during recording. This temporarily lowers the coercivity so that the media can be recorded to. When the media cools, the high coercivity ensures that the recorded data remains stable.

However, the heating devices used to produce such localized heating are, necessarily, large. As such, they extend through the suspension assembly at a side opposite the slider. During a physical shock to the disk drive, there is a risk that the heating devices of adjacent sliders can contact one another, causing damage to one or both of the devices.

### SUMMARY OF THE INVENTION

The present invention provides a suspension that includes, a suspension body having a first side and a second side opposite the first side, the suspension body being configured to hold a slider adjacent to the first side of the suspension body; and a protective structure extending from the second side of the suspension body.

The protective structure can be connected with a slider that has a heating element formed thereon. The heating element, being necessarily large, extends through an opening in the suspension to extend from the suspension at the side opposite the slider.

The protective structure is configured to protect the heating element from contacting other components of the disk drive system such as a heating element of another suspension assembly.

The protective structure can be formed at an angle relative to a longitudinal axis of the suspension to ensure that protective structures of adjacent suspensions contact one another in order to protect the heating elements of the suspension assemblies.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an enlarged side view of a plurality of magnetic disks and suspension assemblies;

FIGS. 3 is an enlarged cross sectional view of a portion of a slider according to an embodiment of the invention;

FIG. 4 is a side view of a suspension assembly and slider according to an embodiment of the invention;

FIG. 5 is a top down view of the suspension assembly of FIG. 4, as seen from line 5-5 of FIG. 4;

FIG. 6 is a side view of a portion of the suspension assembly of FIG. 5 as seen from line 6-6 of FIG. 5; and

FIG. 7 is a view similar to that of FIG. 6 showing an alternate embodiment of the invention.

### DETAILED DESCRIPTION OF THE PREFERRED EMBODIMENTS

The following description is of the best embodiments presently contemplated for carrying Out this invention. This description is made for the purpose of illustrating the general principles of this invention and is not meant to limit the inventive concepts claimed herein.

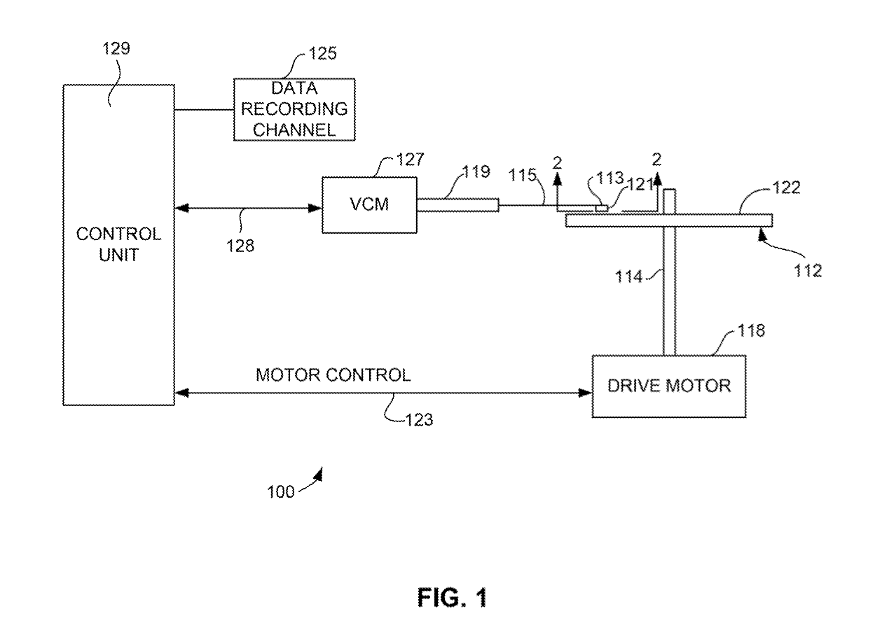

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 can access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

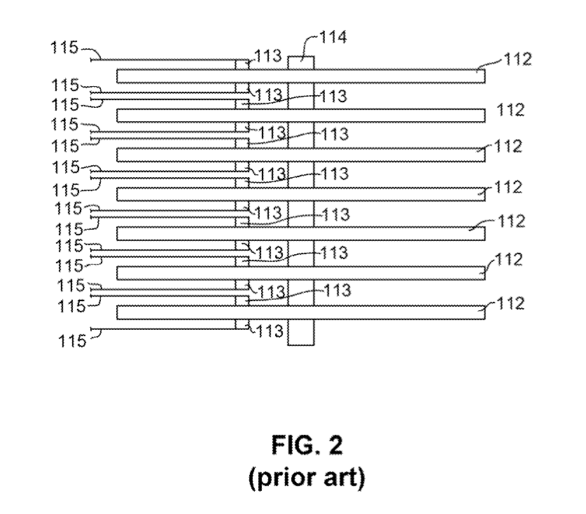

While the view FIG. 1 shows only a single disk 112, this is for purposes of simplicity and clarity in order to schematically describe the disk drive system 100 as a whole. It should be understood, however, that an actual disk drive system includes many disks 112 and many suspension assemblies 115 and sliders 113. FIG. 2 shows a view of a stack of magnetic disk media 112 on a spindle 114. A plurality of suspension assemblies 115 hold a plurality of sliders 113 adjacent to a surface of each of the disks 112. Each of the disks 112 has two surfaces (top and bottom) for recording magnetic data and a suspension 115 and slider 113 can be provided for each of those surfaces.

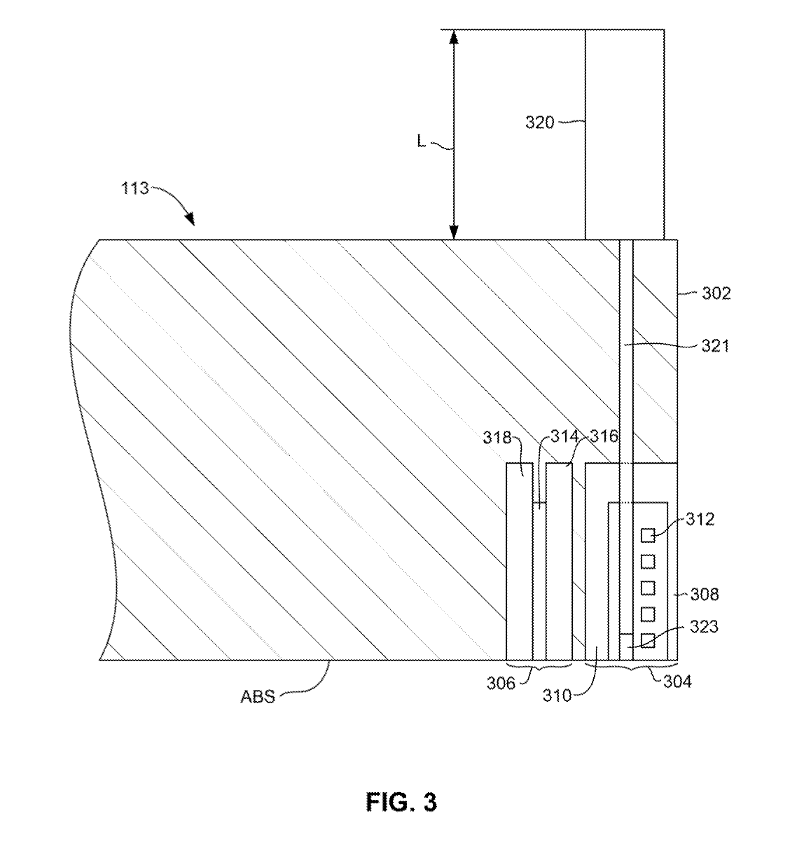

In order to maximize data density while still ensuring writeability of the media, the data recording system can be constructed for thermally assisted recording. FIG. 3, shows an enlarged view of a portion of a slider 113 configured for thermally assisted recording. The slider 113 includes a slider body 302, which can be constructed of a material such as TiC or some other suitable, hard, non-magnetic, dielectric material. A write head 304 is formed on a trailing edge of the slider body 302 and a read head 306 is formed adjacent to the write head 304.

The write head 304 can include a magnetic write pole 308, a magnetic return pole 310, and an electrically conductive, non-magnetic write coil 312. When current flows through the write coil, a resulting magnetic field causes a write field to be emitted from the tip of the write pole 308. This write field, which emits from the relatively small write pole 308 is dense and strong and writes to a magnetic recording layer of an adjacent magnetic medium (not shown in FIG. 3). The resulting magnetic flux flows through the medium and returns to the return pole 310. Because the return pole 310 has a larger cross section at the ABS than the write pole 308 does, the magnetic field returning to the return pole is sufficiently spread out and weak that it does not erase the previously recorded bit of data. The read head 306 also includes a magnetoresistive sensor 314 such as a Giant magnetoresistive Sensor (GMR) or Tunnel Junction Magnetoresistive sensor (TMR), which is sandwiched between first and second magnetic shields 316, 318.

As discussed above, in order to increase data density, the size of magnetic bits recorded on a magnetic medium must be reduced. However, when these magnetic bits become very small, they can be easily demagnetized, either by high temperature or simply becoming self demagnetized even at room temperature. One way to ensure the magnetic stability of the medium is to construct the magnetic medium with a very high magnetic coercivity. However, if the magnetic coercivity is high enough to ensure magnetic stability at very small bit sizes, it is also too high for the magnetic write head 304 to write to. The write head 304 cannot generate a sufficiently strong write field to overcome the high coercivity of the media, especially when the write pole must be made very small to record the very small bit size.

One way to overcome this obstacle is to use thermally assisted recording (TAR). Using TAR, the magnetic media is locally heating during magnetic recording. This temporarily lowers the coercivity of the magnetic media so that the magnetic write head 304 can write to the media. Thereafter, the media quickly cools, again raising the coercivity of the media and ensuring its magnetic stability.

In order to achieve this heating, the slider 113 is equipped with a thermal heating element such as a light source (e.g. laser) 320. A light delivery device 321 such as a fiber optic line extends through the slider 302 to deliver the light from the light source 320 to the ABS at a location preferably within the write head 304. An optical transducer 323 can be provided at the end of the light deliver device 321, at the ABS to focus the light and convert it to heat for heating the adjacent magnetic medium (not shown in FIG. 3). More specifically, the heating device 320 can include a laser and a sub-mount structure (not shown separately in FIG. 3). In order to provide the desired heating for TAR, such a heating device must be constructed large relative to the slider 113, so that the heating device extends significantly through the back side (opposite the air bearing surface (ABS)), as shown in FIG. 3. A typical laser diode and sub-mount structure 320 has a length L of about 350 um, while a tolerance study shows the maximum length L is 250 um. Because the heating device 320 extend significantly beyond the back side of the slider 302, there is a high likelihood that heating elements of adjacent, opposite facing sliders 113 will crash into one another during a high shock event, especially during non-operational shock when the sliders 113 and suspension assemblies 115 are parked on a ramp (not shown). As can be seen in FIG. 2, adjacent sliders 113 configured for recording to adjacent disks 112 are close to one another so that a deflection of the suspension 115 can allow the heating elements (320) FIG. 3 of the sliders 113 (FIG. 2) to contact one another. As can be appreciated, any contact between heating elements 320 can easily cause damage to the heating elements, rendering them inoperable. Since the coercivity of the medium is high (as described above), recording without a functional heating element 320 would be impossible, and the disk drive system would become inoperable.

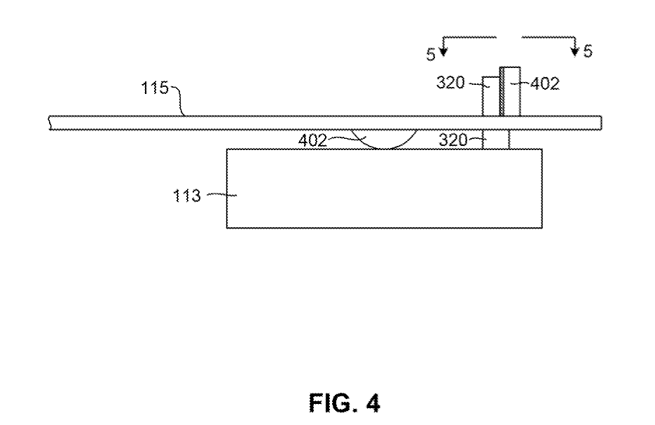

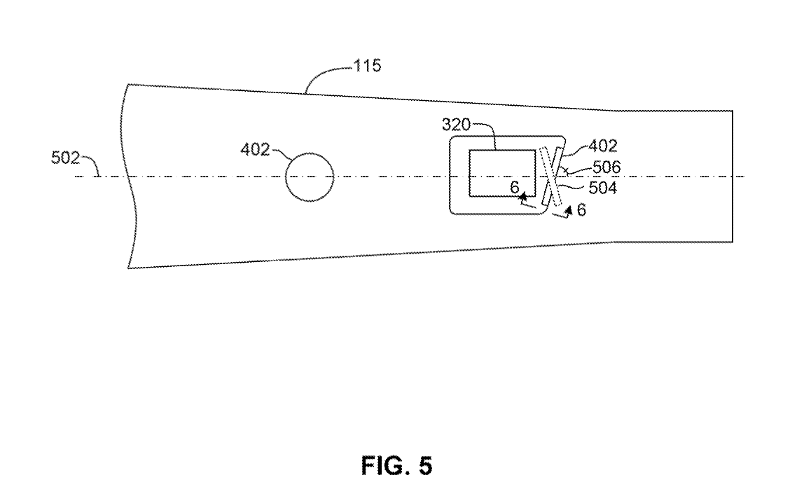

The present invention overcomes this problem, providing a structure that protects the heating element 320 and ensures that no contact between heating elements 320 of adjacent sliders 113 can occur. FIG. 4 shows a side view of a portion of a suspension assembly 115 according to an embodiment of the invention, having a slider 113 mounted thereon. FIG. 5 shows a top down view of the suspension assembly 115 of FIG. 4, as seen from line 5-5 of FIG. 4. The slider 113 can be mounted to a gimbal 402 that can be formed as a bump or dimpled impression in the suspension 115.

As can be seen, the heating element 320 is so long that it actually extends through an opening in the suspension 115. In order to prevent the above contact between heating elements 320 of adjacent sliders 113, a protection structure 402 is formed on the suspension 115. The protective structure 402 can be integral with the suspension 115 and can be easily formed by cutting the material of the suspension 115 during manufacture and bending a tab of material upward as shown in FIGS. 4 and 5. In order to protect the heating element 320, the protective structure 402 extends from the surface of the suspension by a distance that is greater than the distance by which the heating element extends from the surface of the suspension 115. As can be seen in FIG. 5, the protective structure 402 can be formed at a non-right angle 506 relative to the longitudinal axis 502 of the suspension 115. The protective structure 402 is preferably formed at an angle 506 of less than 85 and greater than 45 degrees relative to the longitudinal axis. This ensures that protective structures 402 of adjacent suspension will rest on one another rather than missing each other and allowing the heating elements 320 of adjacent suspension to contact one another. An adjacent suspension 115 would be upside down relative to the suspension 115 shown in FIG. 5. This can be understood with reference to FIG. 2, wherein it can be seen that adjacent suspensions face in opposite directions, one facing upward and another facing downward to read and write adjacent disks. Therefore, with reference again to FIG. 5, if all suspensions 115 have protective strictures 402 that are angled relative to the suspension axis 502 as shown, the orientation of an adjacent suspension with have a protective structure that is oriented at an opposite angle shown in dashed line 504 in FIG. 5. This ensures that the protective structures 402 of adjacent suspensions 115 will contact on another, as stated above.

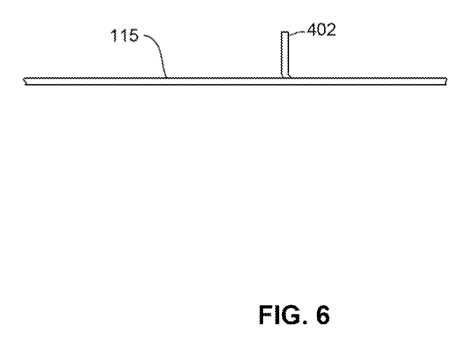

FIG. 6 shows a view as seen from line 6-6 of FIG. 5. As seen in FIG. 6, in one possible embodiment of the invention, the protective structure 402 can extend straight upward (not being bent). As discussed above, the angled orientation of the protective structure 402 (shown in FIG. 5) ensures that the heating element 320 will be protected.

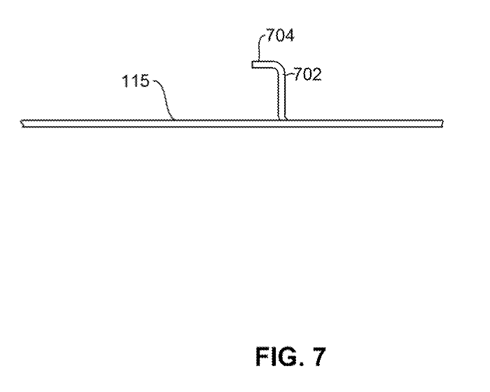

FIG. 7 shows an alternate embodiment of the invention as seen in the same viewing plane as that of FIG. 6. This embodiment provides a protective structure 702 that has a top portion that is bent over to form an overhanging portion 704. While this embodiment involves additional manufacturing steps to construct, it provides additional protection to the heating element 320 (FIG. 5).

While various embodiments have been described above, it should be understood that they have been presented by way of example only and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

1. A suspension, comprising:
a suspension body having a first side and a second side opposite the first side, the suspension body being configured to hold a slider adjacent to the first side of the suspension body; and
a protective structure extending from the second side of the suspension body wherein the suspension body has a longitudinal axis and wherein the protective structure formed at an angle of less than 85 degrees and greater than 45 degrees relative to the longitudinal axis.

2. (canceled)

3. (canceled)

4. The suspension as in claim 1 wherein the protective structure is integral with the suspension body.

5. The suspension as in claim 1 wherein the suspension body is formed with an opening to accommodate a heater element passing there-through.

6. The suspension as in claim 1 wherein the protective structure extends in a direction perpendicular to the second side of the suspension body.

7. The suspension as in claim 1 wherein the protective structure extends in a direction perpendicular to the second side of the suspension body and bends at its top to form an overhanging portion.

8. A suspension assembly for magnetic data recording, comprising:
a suspension having first and second sides and having an opening;
a slider connected with the suspension at the first side of the suspension, the slider having a heating element that passes through the opening in the suspension to extend from the second side of the suspension by a first distance; and
a protective structure formed in the suspension that extends from the second side of the suspension by a second distance that is greater than the first distance;
wherein the suspension has a longitudinal axis and wherein the protective structure is oriented at an angle less than 85 degrees and greater than 45 degrees relative to the longitudinal axis.

9. The suspension assembly as in claim 8, wherein the protective structure is configured to protect the heating element.

10. (canceled)

11. (canceled)

12. The suspension assembly as in claim 8 wherein the protective structure is perpendicular to the second side of the suspension.

13. The suspension assembly as in claim 8 wherein the protective structure extends in a direction perpendicular to the second side of the suspension and bends at its top to form an overhanging portion.

14. A disk drive system, comprising:
a housing;
a plurality of magnetic disks rotatably mounted within the housing;
an actuator;
a suspension assembly connected with the actuator, the suspension assembly further comprising:
a suspension having first and second sides and having an opening;
a slider connected with the suspension at the first side of the suspension, the slider having a heating element that passes through the opening in the suspension to extend from the second side of the suspension by a first distance; and
a protective structure formed in the suspension that extends from the second side of the suspension by a second distance that is greater than the first distance;
wherein the suspension has a longitudinal axis and wherein the protective structure is oriented at an angle less than 85 degrees and greater than 45 degrees relative to the longitudinal axis.

15. The disk drive system as in claim 14, wherein the protective structure is configured to protect the heating element.

16. (canceled)

17. (canceled)

18. The disk drive system as in claim 14 wherein the protective structure is perpendicular to the second side of the suspension.

19. The disk drive system as in claim 14 wherein the protective structure extends in a direction perpendicular to the second side of the suspension body and bends at its top to form an overhanging portion.

20. The disk drive system as in claim 14 further comprising a plurality of magnetic disks and a plurality of suspension assemblies, each suspension assembly comprising, a suspension having first and second sides and having an opening; a slider connected with the suspension at the first side of the suspension, the slider having a heating element that passes through the opening in the suspension to extend from the second side of the suspension by a first distance; and a protective structure formed in the suspension that extends from the second side of the suspension by a second distance that is greater than the first distance and configured to protect the heating element of the suspension assembly from contacting a heating element of an adjacent suspension assembly.

21. A suspension, comprising:
a suspension body having a first side and a second side opposite the first side, the suspension body being configured to hold a slider adjacent to the first side of the suspension body; and
a protective structure extending from the second side of the suspension body;
wherein the suspension body has a longitudinal axis and wherein the protective structure formed at an angle of is neither perpendicular to nor parallel with the longitudinal axis.
